(19) United States
(12) Patent Application Publication
(10) Pub. No.: US 2024/0115933 A1
(43) Pub. Date: Apr. 11, 2024

(54) GROUP CONTROL OF COMPUTER GAME USING AGGREGATED AREA OF GAZE

(71) Applicant: Sony Interactive Entertainment Inc., Tokyo (JP)

(72) Inventor: Sarah Karp, San Mateo, CA (US)

(21) Appl. No.: 18/045,165

(22) Filed: Oct. 9, 2022

(51) Int. Cl. A63F 13/213; G06F 3/01

(52) U.S. Cl. CPC A63F 13/213; G06F 3/013

(57) ABSTRACT

Groups of people control a computer game using teamwork. This can be done by eye tracking of each person to detect where each person is looking on screen at objects such as game control objects. The control action of the object looked at by the most people in a “heat map” style of data collection is implemented by the game.

### FIELD

The present application relates generally to group control of computer simulations such as computer games using aggregated areas of gaze.

### BACKGROUND

As understood herein, computer simulations such as computer games increasingly can be group-oriented.

### SUMMARY

As further understood herein, enjoyable and intuitive group control of computer games can be facilitated.

Accordingly, an apparatus includes at least one processor configured with instructions that are executable to identify respective gaze directions of plural viewers of a computer simulation, and based at least in part on the gaze directions, generate an input signal to the computer simulation.

The input signal may be a single input signal determined by the gaze directions. Or, the input signal may be a selection signal identifying one of plural options presented in the computer simulation.

In some examples the input signal includes a character control signal to control a character in the computer simulation. Or, the input signal can include a vote. Yet again, the input signal can include a navigation command.

In non-limiting implementations a first set of gaze directions is directed at a first object in the computer, a second set of gaze directions is directed at a second object in the computer simulation, the input signal corresponds to the first object, and the input signal is generated based on the first set of gaze directions being greater than the second set of gaze directions.

The computer simulation may be a 3D simulation, or it may be a legacy 2D computer simulation. A gaze direction may be counted only responsive to a gaze being at a location for at least a threshold duration.

In another aspect, a method includes imaging the eyes of plural players of a computer simulation, and based on the imaging, identifying a crowd-based input command for the computer simulation.

In another aspect, a device includes at least one computer storage that is not a transitory signal and that in turn includes instructions executable by at least one processor to track gazes of plural users of a computer simulation, and implement community-based control of the computer simulation based on the gazes.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example specific system consistent with present principles;

FIG. 3 illustrates a screen shot of an example user interface (UI);

FIG. 4 illustrates example overall logic in example flow chart format;

FIG. 5 illustrates first example specific logic in example flow chart format;

FIG. 6 illustrates first example specific logic in example flow chart format; and

FIG. 7 illustrates an example screen shot schematically illustrating group gaze points.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

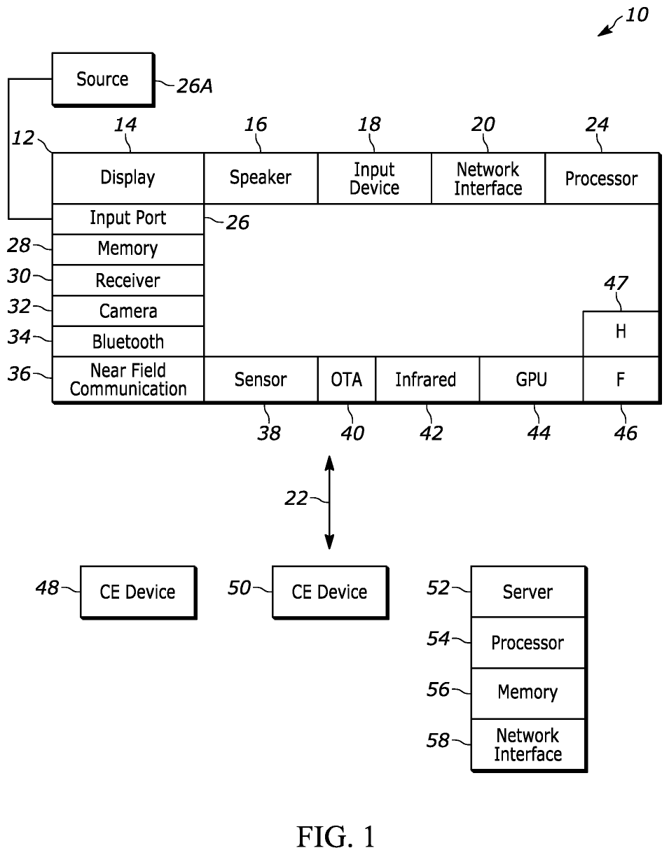

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

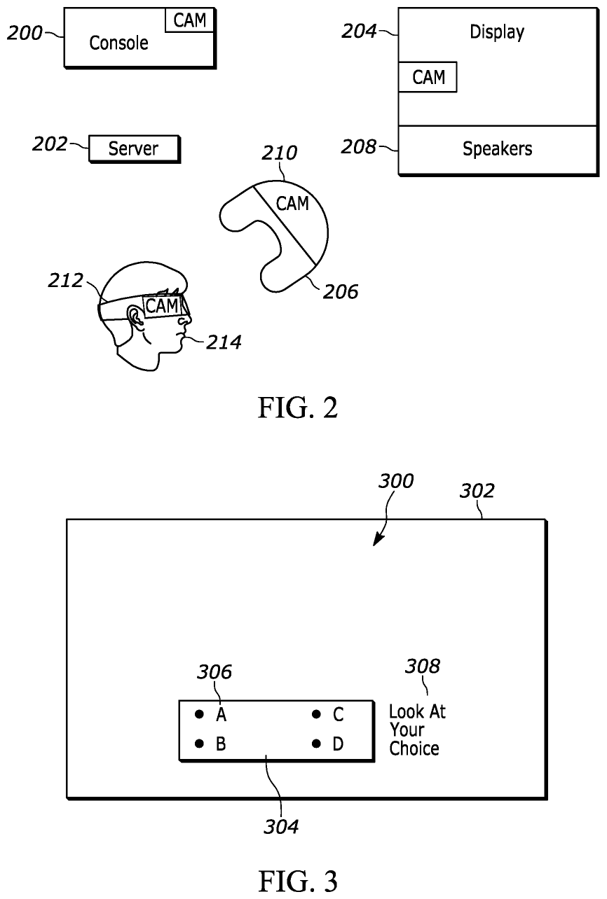

Refer now to FIG. 2. A computer simulation such as a computer game such as a legacy 2D game may be sent from a computer game console 200 or a computer game server 202 to a display device 204 such as a TV for presentation of the computer simulation under control of one or more computer simulation controllers 206, such as but not limited to a PlayStation® controller or other controller.

One or more haptic generators speakers 208 may play audio sourced from the game console 200 or server 202. One or more of the components shown in FIG. 2 may include one or more cameras 210, including a camera on a head-mounted device 212 that may be worn by a player 214 of a virtual reality (VR) or augmented reality (AR) computer simulation such as a computer game. The elements of the system shown in FIG. 2 can incorporate some or all of the appropriate devices and components described above in reference to FIG. 1.

FIG. 3 illustrates a UI 300 that may be presented on a display 302 such as any display herein. The UI 300 in FIG. 3 includes a selector area 304 containing plural selectors 306 (labeled A-D in FIG. 3). A prompt 308 may be provided for a plyer to look at the selector 306 corresponding to the player's choice. The choices represented by the selectors 306 may include, e.g., game character actions, non-character selections such as votes, navigation commands, etc.

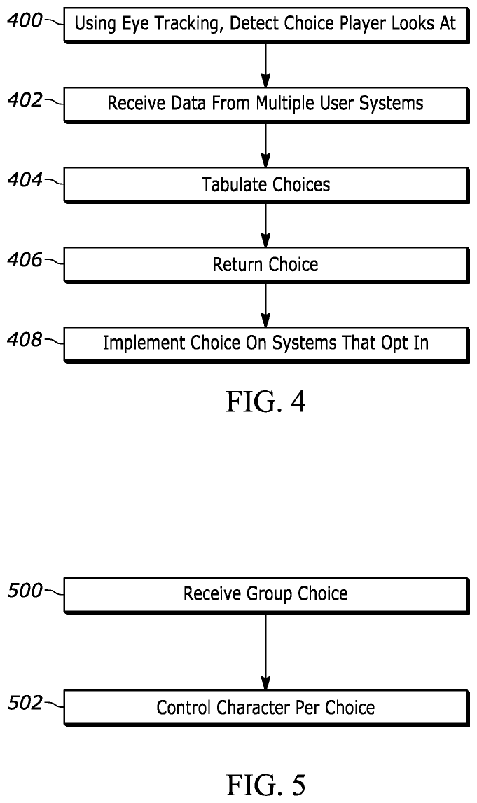

FIG. 4 illustrates further. Commencing at block 400, using eye tracking on images from any of the cameras herein, for each of plural players, their choices are detected by detecting what selector, for instance, from FIG. 3 the player is looking at. In some embodiments a player's gaze must dwell on a selector at least a threshold period of time for the gaze to count as a selection.

Proceeding to block 402, data concerning player's choices as detected by eye tracking at block 400 is received in the aggregate, with choices being tabulated at block 404 by how many players selected each choice. The choice with the highest number of player gaze selections is returned at block 406 and the associated action is implemented at block 408, if desired only for game systems that have opted in to community control.

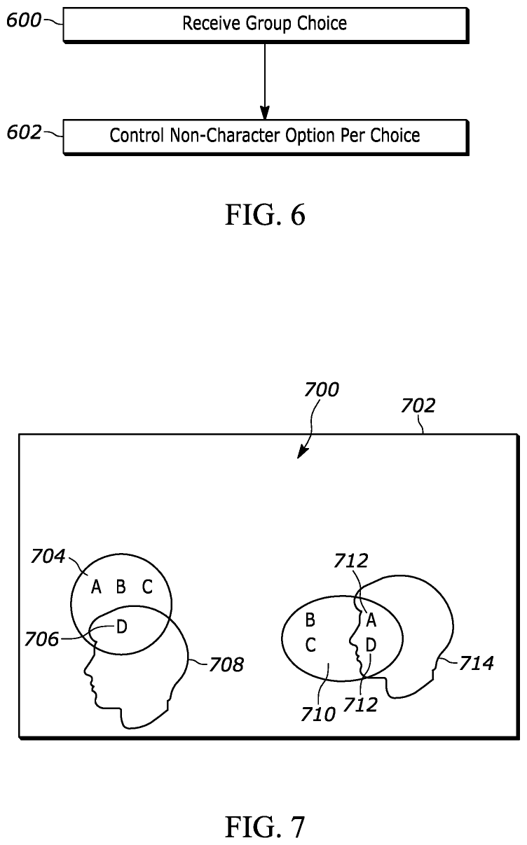

FIGS. 5 and 6 illustrate specific use cases. In FIG. 5, at block 500 the gaze-based group or community choice from FIG. 4 is received and a character in a simulation such as a player character in a computer game is controlled according to the choice.

In contrast, in FIG. 6 the gaze-based group or community choice is received at block 600 and a non-character option is controlled according to the choice at block 602. For example, an up arrow may have been gazed at by the most players, in which case a screen cursor or other object may be moved up on a display. Or, a vote may be recorded based on the most popular group or community selection from a set of options on which the players can vote.

FIG. 7 illustrates a UI 700 that can be presented on a display 702 to present a glanceable heatmap to dictate community gaming actions. In FIG. 7 assume that the region 704 indicates the area of gaze of a first player and area 708 indicates the area of gaze of a second player, it being understood that more players may be accounted for.

The option 706 (labeled “D” in FIG. 7) is in the region in which the gaze areas of the two players overlap (in some embodiments, for the requisite gaze dwell time), and so is determined to be the community selection. The selection is recorded and the most popular gaze-based selection in the community thus identified to precipitate the action associated with the most popular location/selection.

Similarly, a region 710 indicates the area of gaze of a first player and area 714 indicates the area of gaze of a second player, it being understood that more players may be accounted for.

The options 712 (labeled “A” and “D” in FIG. 7) is in the region in which the gaze areas of the two players overlap (in some embodiments, for the requisite gaze dwell time), and so is determined to be the community selection. The selections in this case are recorded and the most popular gaze-based selections in the community thus identified to precipitate the actions associated with the most popular location/selections. Thus, multiple input commands may be associated with a single region in which the gazes of the most players overlap.

While the particular embodiments are herein shown and described in detail, it is to be understood that the subject matter which is encompassed by the present invention is limited only by the claims.

What is claimed is:

1. An apparatus, comprising:
at least one processor configured with instructions executable to:
identify respective gaze directions of plural viewers of a computer simulation; and
based at least in part on the gaze directions, generate an input signal to the computer simulation.

2. The apparatus of claim 1, wherein the input signal is a single input signal determined by the gaze directions.

3. The apparatus of claim 1, wherein the input signal is a selection signal identifying one of plural options presented in the computer simulation.

4. The apparatus of claim 1, wherein a first set of gaze directions is directed at a first object in the computer, a second set of gaze directions is directed at a second object in the computer simulation, the input signal corresponds to the first object, and the input signal is generated based on the first set of gaze directions being greater than the second set of gaze directions.

5. The apparatus of claim 1, wherein the input signal is a character control signal to control a character in the computer simulation.

6. The apparatus of claim 1, wherein the computer simulation is a 2D computer simulation.

7. The apparatus of claim 1, wherein the input signal comprises a vote.

8. The apparatus of claim 1, wherein a gaze direction is counted only responsive to a gaze being at a location for at least a threshold duration.

9. The apparatus of claim 1, wherein the input signal comprises a navigation command.

10. A method comprising:
imaging the eyes of plural players of a computer simulation; and
based on the imaging, identifying a crowd-based input command for the computer simulation.

11. The method of claim 10, wherein the input command is a single input command determined by the gaze directions.

12. The method of claim 10, wherein the input command is a selection signal identifying one of plural options presented in the computer simulation.

13. The method of claim 10, wherein the input command comprises a character control signal to control a character in the computer simulation.

14. The method of claim 10, wherein the input command comprises a vote.

15. The method of claim 10, wherein the input signal comprises a navigation command.

16. A device comprising:
at least one computer storage that is not a transitory signal and that comprises instructions executable by at least one processor to:
track gazes of plural users of a computer simulation; and
implement community-based control of the computer simulation based on the gazes.

17. The device of claim 16, comprising the at least one processor.

18. The device of claim 16, wherein the instructions are executable to:
control at least one character in the computer simulation based on the gazes.

19. The device of claim 16, wherein the instructions are executable to:
identify at least one vote based on the gazes.

20. The device of claim 16, wherein the instructions are executable to:
input at least one screen navigation command based on the gazes.
